(19) United States
(12) Patent Application Publication
(10) Pub. No.: US 2006/0034736 A1
(43) Pub. Date: Feb. 16, 2006

(54) Microreactor

(75) Inventors: Akira Miura, Tokyo (JP); Morio Wada, Tokyo (JP); Tsuyoshi Yakihara, Tokyo (JP); Katsuya Ikezawa, Tokyo (JP); Sadaharu Oka, Tokyo (JP); Shinji Kobayashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/199,365

(22) Filed: Aug. 9, 2005

(30) Foreign Application Priority Data
Aug. 10, 2004 (JP) P.2004-232881

(51) Int. Cl. B01J 19/00

(52) U.S. Cl. 422/129

(57) ABSTRACT

A microreactor has a plurality of flow channels, a joint flow channel where the plurality of flow channels are joined, a light applying section which applies light, that accelerates a reaction of fluids which flows through the plurality of flow channels to join in the joint flow channel, to the joint flow channel; and an applying section which applies a magnetic field and/or an electric field to a reaction production substance.

### CROSS-REFERENCE TO RELATED APPLICATIONS

This application is based upon and claims the benefit of priority from the prior Japanese Patent Applications No. 2004-232881, filed on Aug. 10, 2004, the entire contents of which are incorporated herein by reference.

### BACKGROUND OF THE INVENTION

1. Field of the Invention

In recent years, researches on controlling creation of super molecules making the most of a photocalytic chemical reaction and a photo-enzyme chemical reaction using laser light and separation and purification of biochemical substances of an enzyme, a protein, etc., using a photoreaction have advanced. Application to state analysis such as spectral analysis using plasma generated by laser light has also advanced. The invention relates to a microreactor as a reaction vessel used in such a field.

2. Description of the Related Art

The microreactor is a very small-sized reaction vessel and is formed of a substance whose physico-chemical characteristic is clear, such as silicon, crystal, polymer, or metal; generally it is worked to a length of several cm with the flow channel of a fluid measuring about 10 to 100 μm in diameter using micromachining technology of microelectronics, micromachine (MEMS), etc.

If a vessel for causing a biochemical reaction is micro-sized, a peculiar effect appears in a minute space. As the scale effect of a micromachine, blending is promoted and a reaction easily occurs because of dispersion of molecules without blending a reaction liquid due to an increase in the ratio of surface to volume accompanying the microsizing. That is, if the scale is small, a laminar-dominated flow results; if the dispersion length is shortened, blending in a short time is possible.

The following documents are known as related arts of such a microreactor.

[Document 1] FUJII Teruhito: “Shuusekigata microreactor chip,” Nagare vol. 20 No. 2 (published in April 2001), pp. 99-105

[Document 2] SOTOWA Kenichirou, KUSAKABE Katsumi: “Microreactor de kiwameru CFD,” Fluent Asian Pacific News Letter Fall (2002)

[Document 3] JP-A-2003-126686

FIGS. 3A and 3B show the configuration of a microreactor described in documents 1 and 2, wherein two liquids are allowed to flow into a joint flow channel where flow channels are joined as shaped like a letter Y, and reaction of the two liquids is caused. FIG. 3A is a plan view and FIG. 3B is a sectional view taken on line A-A in FIG. 3A.

In FIGS. 3A and 3B, numeral 10 denotes a first substrate (PDMS resin (Poly-dimethyloxane) as a laser light transmission material) formed with a groove 11, which is made up of a first flow channel 11a, a second flow channel 11b, and a joint flow channel 11c. Numeral 12a denotes a first inflow port formed at an end part of the first flow channel 11a, numeral 12b denotes a second inflow port formed at an end part of the second flow channel 11b, and numeral 13 denotes an outflow port formed at an end part of the joint flow channel 11c. Numeral 14 denotes a second substrate (PMMA (Methacrylic resin) as a laser light transmission material), which is fixed covering the side where the groove of the first substrate 10 is formed. The cross section of the groove of the microreactor is about 100 μm².

FIG. 3C shows a state in which fluids different in component flowing through the first and second flow channels 11a and 11b join in the joint flow channel; since the scale is small, a laminar-dominated flow results. Thus, within the flow channel of microscale, mostly the Reynolds number is smaller than one; it can be used for performing extraction operation between the two types of liquid phases, etc., for example. Although the state is the laminar state, if the flow width is lessened (the dispersion length is shortened), blending can be executed in a short time.

FIGS. 4A to 4C are plan views to show the configuration of a microreactor described in document 3. Parts similar to those previously described with reference to FIGS. 3A to 3C are denoted by the same reference numerals in FIGS. 4A to 4C.

In FIG. 4A, a notch 23 is formed in the vicinity of the joint point where first and second flow channels join, and a partition wall from the bottom to a joint flow channel 11c measures about 10 μm in thickness and the heating range is about 100 μ. Numeral 20 denotes laser light narrowed through a lens. In this example, SUS, aluminum, glass, etc., is used as the material of a first substrate 10.

FIGS. 4B and 4C show examples wherein the first substrate 10 is formed of an optically transparent material of glass, transparent plastic, etc., and is used to directly form a convex lens and a Fresnel lens. Also in this case, laser light is applied through the convex lens and the Fresnel lens for heating and accelerating a chemical reaction of fluid flowing through the joint flow channel.

By the way, the microreactor using the microflow channel in the related art shown in FIGS. 3A to 3C is intended for reaction based on dispersion of molecules by joining the flow channels, and the microreactor shown in FIGS. 4A to 4C is intended for controlling the temperature, etc., by a laser for accelerating the chemical reaction of fluid flowing through the joint flow channel.

However, only limited chemical reactions can be obtained simply by heating depending on the type of fluid. When a fluid flowing through the joint flow channel is heated by a laser, the area where the light strength is strong becomes the main reaction area and thus when production and reaction occur, the effects of contamination from a wall face, surface reaction of a wall face, etc., are received.

### SUMMARY OF THE INVENTION

An object of the invention is to provide a microreactor wherein a microflow channel is branched so as to blend fluids and cause fluids to react with each other, and a mechanism for applying an electric field or a magnetic field is provided in the branch part so as to separate and concentrate a reaction product.

The invention provides a microreactor, including: a plurality of flow channels; a joint flow channel where the plurality of flow channels are joined; a light applying section which applies light, that accelerates a reaction of fluids which flows through the plurality of flow channels to join in the joint flow channel, to the joint flow channel; and an applying section which applies a magnetic field and/or an electric field to a reaction production substance.

In the microreactor, the joint flow channel is branched into a plurality of channels on a downstream side, and the applying section is provided adjacent to the branch part.

In the microreactor, the light applied from the light applying section is laser light, the light applying section applies the laser light through a lens, and the laser light is narrowed through the lens so that a beam waist of the laser light in the joint flow channel is smaller than the joint flow channel in width.

According to the microreactor, it is possible to accelerate a specific chemical reaction, and separate and concentrate a specific reaction production substance that are impossible in the method using blending and chemical reaction by dispersion in a microflow channel controlling the temperature, pressure, etc., of the microflow channel in the related art.

Further, a reactor that is free of the effects of contamination from the wall face, surface reaction of the wall face, etc., can be provided.

### BRIEF DESCRIPTION OF THE DRAWINGS

FIG. 1 is a drawing to show one embodiment of a microreactor of the invention;

FIGS. 2A and 2B are schematic representation to show the position of a beam waist of laser light;

FIGS. 3A to 3C are schematic representation of a microreactor in a related art; and

FIGS. 4A to 4C are schematic representation of a microreactor in a related art.

### DETAILED DESCRIPTION OF THE PREFERRED EMBODIMENTS

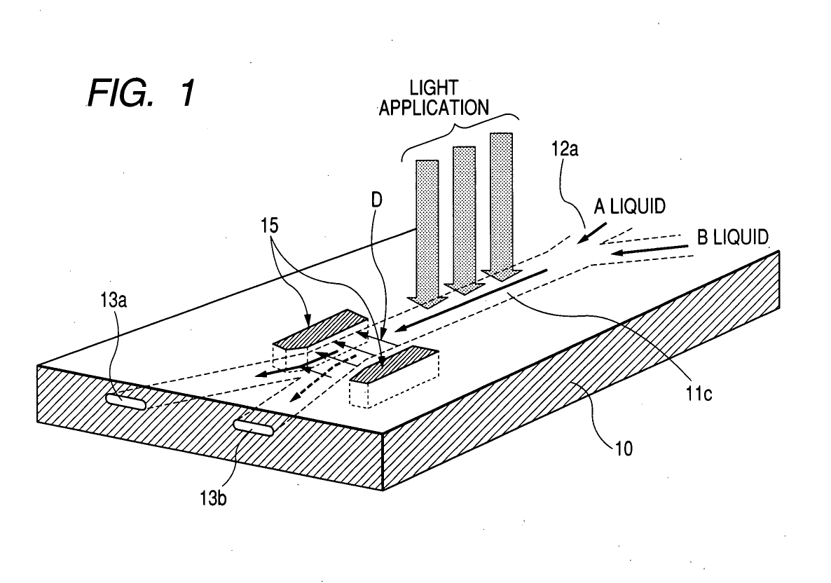

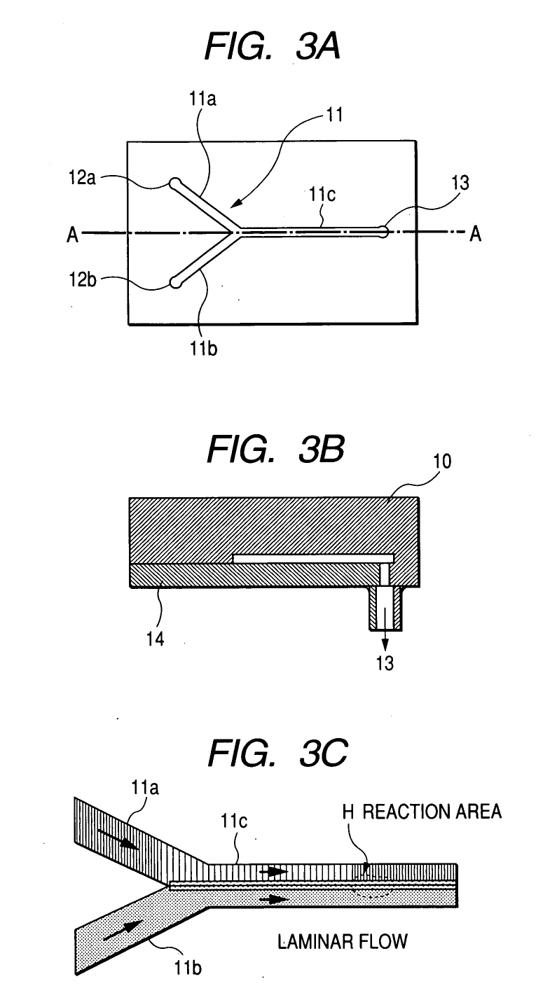

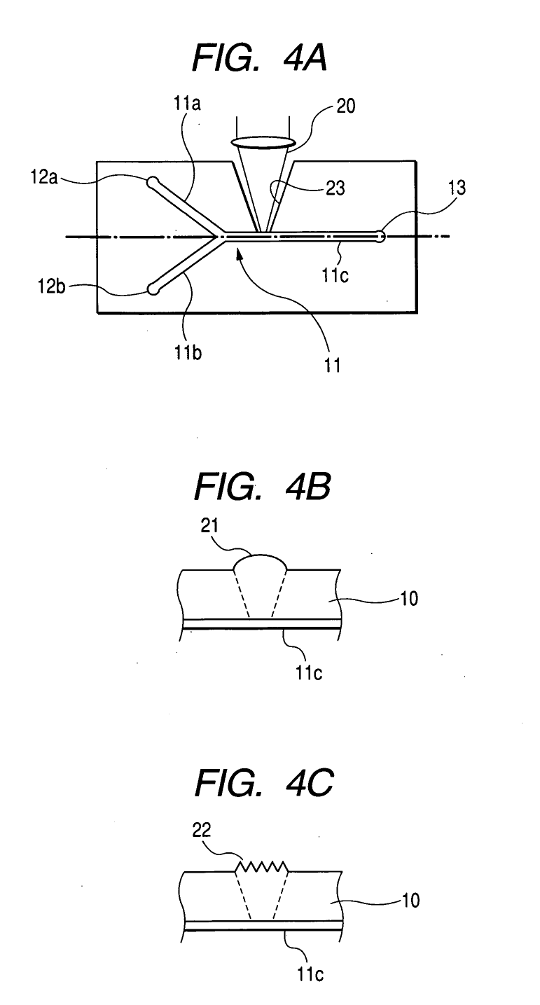

FIG. 1 shows an embodiment of the invention. Parts similar to those in the related art examples previously described with reference to FIGS. 3A to 3C and FIGS. 4A to 4C are denoted by the same reference numerals in FIG. 1.

In FIG. 1, A liquid flows into a reactor from a first inflow port 12a and B liquid flows into the reactor from a second inflow port 12b. These liquids join in a joint flow channel 11c and flow out through first and second outflow ports 13a and 13b.

Although not shown, a second substrate similar to that previously described with reference to FIGS. 3A to 3C in the related art example is formed on the side where the joint flow channel 11c of a first substrate 10 is formed, and covers the inflow ports 12a and 12b and the outflow ports 13a and 13b.

As shown in FIG. 1, the microreactor of the invention includes the first and second inflow ports 12a and 12b shaped like a letter Y for introducing two types of fluids (in the embodiment, A liquid and B liquid), the joint flow channel 11c where these liquids are joined and light is applied, and an electric field applying section (electrodes) 15, for example, in the vicinity of an exit where the reacting fluid is again caused to branch into the first and second outflow ports 13a and 13b so that an electric field (D) can be applied.

After the two liquids are joined, they react with each other as they are blended by dispersion of molecules. Here, photochemical reaction is controlled (accelerated) by applying a laser using a laser emission device (not shown) in the middle of the joint flow channel 11c.

A transparent material for excitation light is used as the flow channel material of the reaction portion so that the reaction liquid absorbs light and the reaction is accelerated. If the photoreaction is reaction based on resonance absorption occurring at a specific wavelength, for example, specific chemical reaction can be controlled using a variable wavelength light source (for example, tunable wavelength laser) for the excitation light. FIG. 1 shows a state in which a specific reaction production substance is photo-excited and ionized by applying three types of light different in wavelength.

When the reaction production substance occurring here is caused to branch in the branch part to the first and second outflow ports 13a and 13b (Y-shaped flow channel), the electric field applying section 15 provided in the branch part applies an electric field to the reaction production substance in the branch part. Consequently, it is made possible to separate or concentrate the photo-excited ionized reaction production substance in one flow channel after branch.

In the embodiment, reaction acceleration by applying light of a specific wavelength, photoexcitation and ionization based on specific wavelengths, and separation and concentration by applying an electric field are added as the functions in the microreactor, but a magnetic field rather than an electric field can also be applied to the branch part of the Y-shaped flow channel in response to the type of reaction production substance.

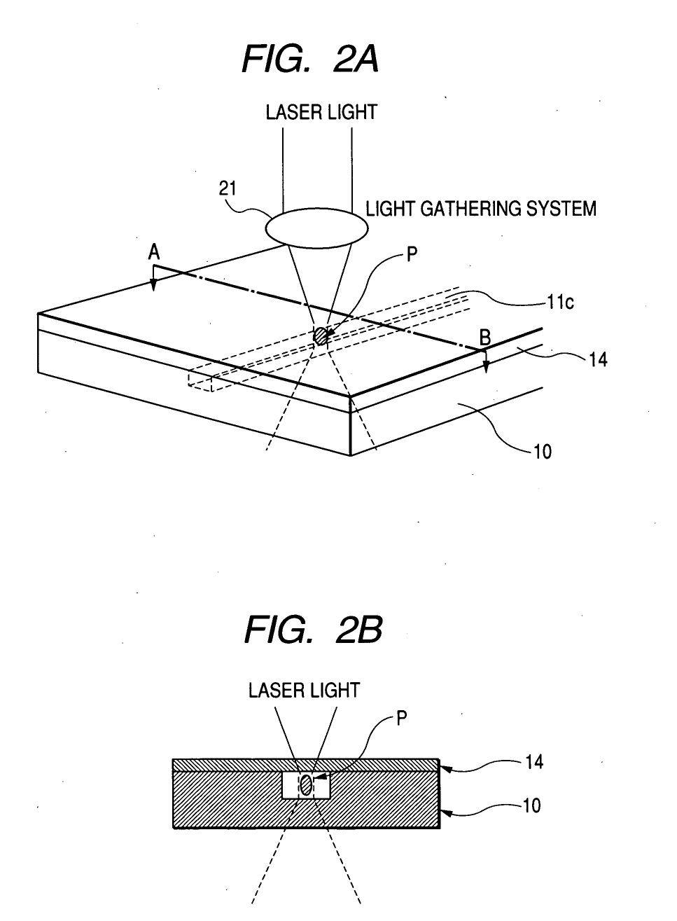

FIGS. 2A and 2B are schematic representation to show the position of a beam waist of laser light. FIG. 2B is a sectional view taken on line A-B in FIG. 2A. The figures show only the portion of the joint flow channel 11c shown in FIG. 1. In the example, a light transmission material with small light absorption, for example, a material of quartz, etc., is used as the materials of the first and second substrates. In this case, laser light is applied through a lens 21 and laser is narrowed through the lens 21 to such an extent that it does not come into contact with either side wall of the joint flow channel 11c.

That is, as shown in FIG. 2B, for the laser light gathered in the joint flow channel 11c, beam waist P with high light strength is positioned at a distance from each wall face and the area where the light strength is high becomes the main reaction area. In other words, the beam waist P of the laser light in the joint flow channel 11c is smaller than the joint flow channel 11c in width. Therefore, if production and reaction occur in the area where the light strength is strong, the effects of contamination from the wall face, surface reaction of the wall face, etc., can be prevented.

The above embodiment of the invention described above is only illustrative for the description of the invention. Therefore, it is to be understood that the invention is not limited to the above embodiment described above and that the invention includes various changes and modifications without departing from the spirit and scope of the invention.

What is claimed is:

1. A microreactor, comprising:
a plurality of flow channels;
a joint flow channel where the plurality of flow channels are joined;
a light applying section which applies light, that accelerates a reaction of fluids which flows through the plurality of flow channels to join in the joint flow channel, to the joint flow channel; and
an applying section which applies a magnetic field and/or an electric field to a reaction production substance.

2. The microreactor according to claim 1,
wherein the joint flow channel is branched into a plurality of channels on a downstream side, and
the applying section is provided adjacent to the branch part.

3. The microreactor according to claim 1,
wherein the light applied from the light applying section is laser light,
the light applying section applies the laser light through a lens, and
the laser light is narrowed through the lens so that a beam waist of the laser light in the joint flow channel is smaller than the joint flow channel in width.
